(19) United States
(12) Patent Application Publication
(10) Pub. No.: US 2009/0314746 A1
(43) Pub. Date: Dec. 24, 2009

(54) ARC-QUENCHING CORE ASSEMBLY

(75) Inventors: Thilo BAHLINGER, Rulzheim (DE); Joachim BECKER, Schwetzingen (DE)

Correspondence Address: BUCHANAN, INGERSOLL & ROONEY PC, POST OFFICE BOX 1404, ALEXANDRIA, VA, 22313-1404, US

(73) Assignee: ABB AG, Mannheim (DE)

(21) Appl. No.: 12/537,168

(22) Filed: Aug. 6, 2009

Related U.S. Application Data
(63) Continuation of application No. PCT/EP2008/000896, filed on Feb. 6, 2008.

(30) Foreign Application Priority Data
Feb. 7, 2007 (DE) 10 2007 005 996.7

(51) Int. Cl. H01H 33/08

(52) U.S. Cl. 218/34

(57) ABSTRACT

An arc-quenching core assembly is disclosed for an electric switch, such as a circuit-breaker or motor circuit-breaker, having arc-quenching plates, or sheets, arranged in parallel and including ferromagnetic material, wherein the sheets can be at least partially coated on at least one face with another material. The arc-quenching core assembly is composed of a series of first quenching sheets, completely or partially coated on both faces and second uncoated quenching sheets, or of a series of third quenching sheets, completely or partially coated on one face and uncoated on the other, thus creating a series of coated and uncoated arc-quenching sheet broad faces in the stacking direction. The arc-quenching sheets are arranged one behind the other in the stacking direction in such a way that at least two uncoated arc-quenching sheet broad faces are located between a coated arc-quenching sheet broad face and a next coated arc-quenching sheet broad face in the stacking direction.

### RELATED APPLICATIONS

This application claims priority as a continuation application under 35 U.S.C. §120 to PCT/EP2008/000896, which was filed as an International Application on Feb. 6, 2008 designating the U.S., and which claims priority to German Application 10 2007 005 996.7 filed in Germany on Feb. 7, 2007. The entire contents of these applications are hereby incorporated by reference in their entireties.

### FIELD

The disclosure relates to an arc-quenching core assembly.

### BACKGROUND INFORMATION

A known arc-quenching core assembly, also referred to as an arc-quenching laminated core, is fitted in a line-protection circuit breaker or a motor protection circuit breaker. The arc-quenching core assembly is made up of a plurality of arc-quenching lamina, or plates, which are identical with regard to their external shape and dimensions. The plates are, for example, essentially rectangular and are made of metal. They have a V-shaped inlet contour which is open to the point at which the arc originates.

DE 103 12 820 shows an arc-quenching core assembly of the kind described for an electric switch having quenching plates arranged parallel to one another which are held apart from one another by a retaining device made from insulating material.

If an arc is now drawn between a moving contact piece and a fixed contact piece, for example in the event of a short circuit current, then it is guided by arc guide rails, which border the stack of quenching plates on both sides in the stacking direction, into the arc-quenching laminated core where it is divided into sub-arcs, as a result of which the arc voltage increases thus limiting the short circuit current.

Ferromagnetic materials are used as the basic material for the quenching plates, as in the vicinity of a ferromagnetic material the magnetic field which accompanies the arc tries to follow a course through the magnetically better conducting quenching plates. This can result in a suction effect in the direction of the quenching plates. Along with a magnetic blowing field produced by the arc itself, this suction effect can cause the arc to move towards the arrangement of quenching plates and to be divided between these into a plurality of sub-arcs which establish a foothold on the quenching plates.

On occasions it has been proposed to apply special coatings to the individual arc-quenching plates in order to accelerate the quenching of the arc and to accelerate the course of the individual sub-arcs in the arc-quenching laminated core. In doing so, partially conflicting objectives can be placed on the coating on the arc-quenching plates, with the result that a coating which fulfills all the desired objectives equally is not hitherto known.

DE 32 47 681 shows an arc-quenching chamber with an arc-quenching core assembly, each arc-quenching lamina, or plate, being coated with a gas or vapor-emitting material, which vaporizes under the effect of the arc and thereby promotes quenching of the arc. However, this consumes the material and the number of switching operations that can be carried out is therefore limited.

In order that local overheating of the arc-quenching lamination does not occur on the quenching plates at the foot of the arc, high mobility of the feet of the arc on the quenching plates can be desired. For this purpose, it is known to galvanically coat quenching plates with silver or copper. However, with such coatings, there is a risk of local melting and spattering of the melted material occurring under the influence of the arc resulting in short circuits between individual arc-quenching plates.

DE 10 2004 036 113 B4 discloses a coated quenching lamination, the coating having a composite material with at least two constituents. The first constituent is electrically conductive and has a melting point and a vaporization point which do not exceed the melting point and vaporization point respectively of the ferromagnetic base material. The second constituent has a melting point and a vaporization point which are higher than the melting point and vaporization point respectively of the ferromagnetic base material. A coating of this composite material can therefore spatter less than a coating of a pure metal such as silver or copper for example. However, the mobility of the arc can be negatively affected compared with a coating of a metal such as silver or copper.

### SUMMARY

An arc-quenching core assembly for an electric switch is disclosed, comprising: first arc-quenching plates made from ferromagnetic material and arranged parallel to one another, the plates being at least partially coated on at least one side with a coating material; and second arc-quenching plates uncoated on at least one side, the first and second arc-quenching plates being configured in a series of coated and uncoated arc-quenching plate broad sides in a stacking direction, the arc-quenching plates being arranged behind one another in the stacking direction such that at least two uncoated arc-quenching plate broad sides are located between sequential coated arc-quenching plate broad sides in the stacking direction.

An installation switching device is disclosed having an arc-quenching chamber and an arc-quenching core assembly, the arc-quenching core assembly comprising: first arc-quenching plates made from ferromagnetic material and arranged parallel to one another, the plates being at least partially coated on at least one side with a coating material; and second arc-quenching plates uncoated on at least one side, the first and second arc-quenching plates being configured in a series of coated and uncoated arc-quenching plate broad sides in a stacking direction, the arc-quenching plates being arranged behind one another in the stacking direction such that at least two uncoated arc-quenching plate broad sides are located between sequential coated arc-quenching plate broad sides in the stacking direction

### BRIEF DESCRIPTION OF THE DRAWINGS

The disclosure as well as further exemplary embodiments and improvements of the disclosure are explained and described in more detail with reference to the drawings, in which 5 exemplary embodiments of the disclosure are shown.

FIG. 1: shows a perspective view of an exemplary arc-quenching core assembly according to the disclosure;

FIG. 2: shows schematically an exemplary first stacking sequence of completely coated and uncoated arc-quenching plates;

FIG. 3: shows schematically an exemplary second stacking sequence of completely coated and uncoated arc-quenching plates;

FIG. 4: shows schematically an exemplary first stacking sequence of arc-quenching plates coated on one side;

FIG. 5: shows schematically an exemplary second stacking sequence of arc-quenching plates coated on one side; and

FIGS. 6 and 7: show variations of an exemplary partial coating of an arc-quenching plate.

### DETAILED DESCRIPTION

An arc-quenching core assembly is disclosed which can be optimized with regard to arc mobility and thermal stability.

According to the disclosure, an exemplary arc-quenching core assembly is formed of a series of first quenching lamina, or plates, completely or partially coated on both sides, and second uncoated quenching lamina, or plates, or of a series of third quenching lamina, or plates, completely or partially coated on one side and uncoated on the other side, thus creating a series of coated and uncoated arc-quenching plate broad sides in a stacking direction, the arc-quenching plates being arranged behind one another in the stacking direction in such a way that at least two uncoated arc-quenching plate broad sides are located between a coated arc-quenching plate broad side and a next coated arc-quenching plate broad side in the stacking direction.

In an exemplary embodiment of the invention disclosure, the coating of the arc-quenching plates is in this case made from an electrically conductive material.

According to an exemplary embodiment, the arc-quenching core assembly comprises an alternating series of arc-quenching lamina, or plates, coated, (e.g., completely coated) on both sides and uncoated arc-quenching plates, in such a way that every second arc-quenching plate is uncoated. The structure of the arc-quenching chambers is such that an arc-quenching plate coated on both sides and an uncoated arc-quenching plate lie above one another alternately in the stacking direction. The distance between two adjacent arc-quenching plates is chosen to be of the normal order of magnitude, approximately between, for example, 0.5 mm and 2 mm, preferably approximately between, for example 0.6 mm and 1 mm.

An exemplary basic geometrical contour of arc-quenching plates according to the disclosure corresponds to that described above; exemplary embodiments are essentially rectangular and have a V-shaped inlet contour.

According to an exemplary embodiment, a composite material, such as is described, for example, in DE 10 2004 036 113 B4, the disclosure of which is hereby incorporated by reference in its entirety, can be used for the coating material. The material of the coating can be composite material comprising at least two constituents, of which the first constituent is electrically conductive, has a melting point which does not exceed the melting point of the ferromagnetic material, and a vaporization point which does not exceed the vaporization point of the ferromagnetic material, and of which the second constituent has a melting point which is higher than the melting point of the ferromagnetic material and a vaporization point which is higher than the vaporization point of the ferromagnetic material. The composite material itself can be electrically conductive. However, because of the second constituent, the conductivity can be less than with a highly conductive metal such as the already mentioned silver or copper.

As a result of the alternate arrangement of coated and uncoated arc-quenching plate broad sides, disadvantageous effects of known arc-quenching lamination processing options can be minimized while advantageous effects can be maintained. Therefore, with an arc-quenching core assembly according to the disclosure, the thermal stability of the arc-quenching plates can be increased without the mobility of the feet of the arc on the arc-quenching plates being disadvantageously affected.

In a further exemplary embodiment, the arc-quenching core assembly comprises an alternating series of arc-quenching plates partially coated on both sides and completely uncoated arc-quenching plates, in such a way that every second arc-quenching plate is uncoated. Unlike the first embodiment mentioned above, the arc-quenching plates are only partially coated on the arc-quenching plate broad sides. This can save coating material. At the same time, the partial coating can be realized so that, on the arc-quenching plate broad side, a strip is coated which is oriented parallel to the longitudinal or transverse edges of the arc-quenching plate, and the remaining part of the arc-quenching plate broad side remains uncoated.

According to another exemplary embodiment, the arc-quenching core assembly comprises an alternating series of arc-quenching plates completely or partially coated on one side and uncoated on the other side, in such a way that, in the stacking direction, a completely or partially coated arc-quenching plate broad side faces the completely or partially coated arc-quenching plate broad side of an adjacent arc-quenching plate, and the uncoated arc-quenching plate broad side of an arc-quenching plate faces the uncoated arc-quenching plate broad side of an adjacent arc-quenching plate in each case.

According to a further exemplary embodiment, an arc-quenching core assembly according to the disclosure can also be designed so that a completely or partially coated arc-quenching plate broad side of an arc-quenching plate and an uncoated arc-quenching plate broad side of an adjacent arc-quenching plate in each case face one another in the stacking direction.

In an exemplary arc-quenching core assembly according to the disclosure, the arc-quenching plates can advantageously be retained at a desired distance from one another by means of at least one retaining device made from insulating material.

In an exemplary arc-quenching chamber with an arc-quenching core assembly according to the disclosure associated with the contact point of a switch, a switching arc occurring at the contact point can be guided towards the arc-quenching core assembly by means of two arc guide rails so that, after entering, it cools and is quenched in said assembly.

The arc-quenching plate broad sides adjacent to the two arc guide rails can, for example, be uncoated. This can be realized so that the two outermost arc-quenching plates of the arc-quenching core assembly are uncoated.

In a further exemplary embodiment, the arc-quenching plates adjacent to the two arc guide rails can also be coated, which can be realized so that the two outermost arc-quenching plates of the arc-quenching core assembly are coated.

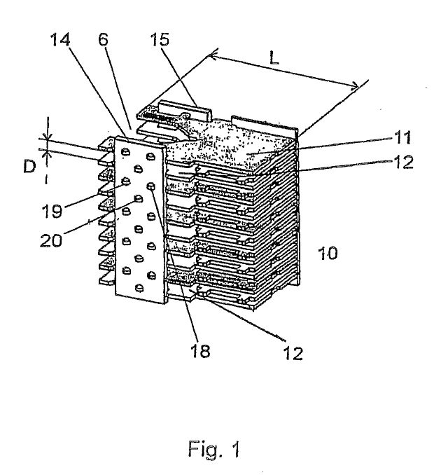

Reference is now made to FIG. 1. An exemplary stack of arc-quenching lamina, or plates, 10 shown here has first arc-quenching plates 11 and second arc-quenching plates 12. The first and second arc-quenching plates 11, 12 are longitudinally extended and rectangular, and in known manner have a V-shaped cutout 6 in their front region which can be described as an inlet recess. The individual arc-quenching plates 11, 12 have a length L1 and assume a distance D1 from one another. The arc-quenching plates 11, 12 can be retained at a distance with respect to one another by means of strips 14, 15, which are arranged on both sides and are, for example, made from insulating material, such as insulating paper or plastic. At the same time, each quenching plate 11, 12 can have recesses on its longitudinal edge in which lugs 18,19, 20, which protrude perpendicular to the longitudinal extension of the longitudinal edge, are located, two lugs 18 and 19 being formed on one longitudinal edge and one lug 20 on the opposite longitudinal edge. When the stack of arc-quenching plates 10 is assembled, every second plate is turned through 180°. In this way, quenching plates with two lugs alternate with quenching plates with one lug referred to a longitudinal edge.

The first arc-quenching plates 11 are, for example, completely coated on both sides. The coating includes, (e.g., consists of) a composite material comprising at least two constituents, of which the first constituent is electrically conductive, has a melting point which does not exceed the melting point of the ferromagnetic material, and a vaporization point which does not exceed the vaporization point of the ferromagnetic material, and of which the second constituent has a melting point which is higher than the melting point of the ferromagnetic material and a vaporization point which is higher than the vaporization point of the ferromagnetic material.

The second arc-quenching plates 12 are uncoated. Arc-quenching plates 11, 12 which are completely coated on both sides and uncoated arc-quenching plates therefore can alternate in the stack of arc-quenching plates 10 in the stacking direction.

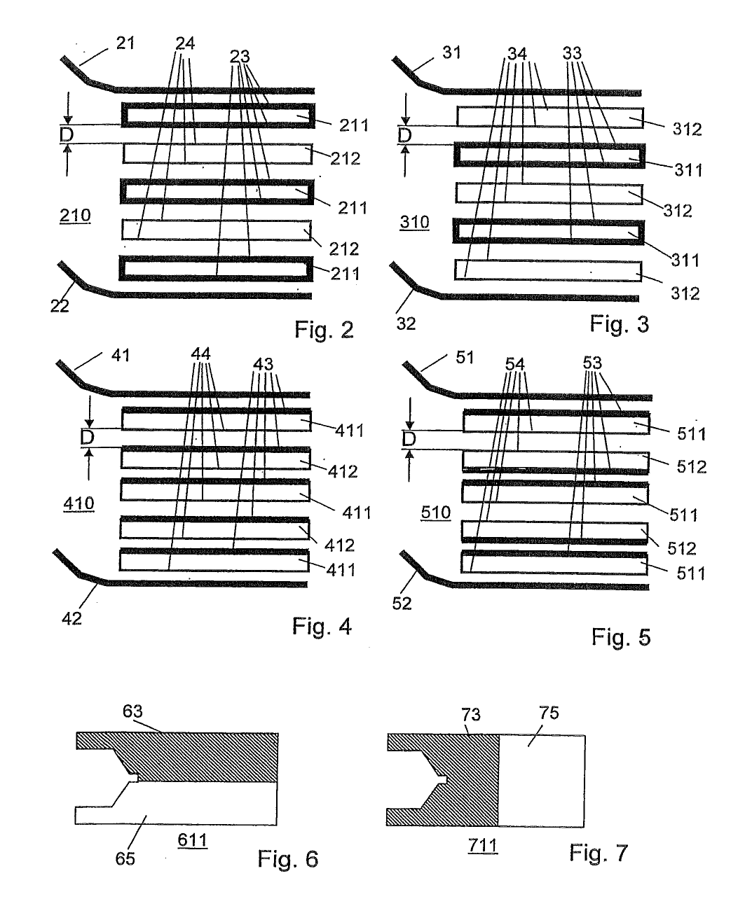

FIG. 2 shows schematically a cross section through an arc-quenching laminated core according to FIG. 1. In FIG. 2, identical elements or elements which have the same effect are designated with the same reference numbers as in FIG. 1, prefixed by the figure number. The same also applies with regard to the reference numbers for the further FIGS. 3 to 7.

In FIG. 2, an arc-quenching laminated core, or lamination, 210 is shown having 5 arc-quenching lamina, or plates, stacked one above the other parallel to its broad side, of which first arc-quenching plates 211 completely coated on both sides alternate with uncoated arc-quenching plates 212. The coating 23 of the first arc-quenching plates 211 is indicated by a thicker contour line. It extends on both broad sides of the arc-quenching plates and also on the narrow sides. In contrast, the broad sides 24 of the second arc-quenching plates 212 are uncoated.

FIG. 2 also shows schematically the interaction of the stack of arc-quenching plates 210 with two arc guide rails 21, 22, which guide the arc occurring at a contact point of the installation switching device to the stack of arc-quenching plates 210. In the embodiment shown in FIG. 2, the arc-quenching plates adjacent to the arc guide rails 21, 22 are coated.

An exemplary variant of an arc-quenching core assembly according to the disclosure is shown in FIG. 3. This differs from the embodiment according to FIG. 2 in that the arc-quenching plates 312 adjacent to the arc guide rails 31, 32 are uncoated. However, the stack of arc-quenching plates 310 also comprises an alternating series of coated and uncoated arc-quenching plates 311, 312 in the embodiment according to FIG. 3.

FIGS. 4 and 5 show further exemplary variants of arc-quenching core assemblies according to the disclosure in which arc-quenching plates 411, 412 coated on one side are used. Each arc-quenching plate in the stack of arc-quenching plates 410 is coated on one broad side with a coating 43 while the opposite broad side 44 is uncoated. The arc-quenching plates are arranged in the stack so that in each case an uncoated broad side of an arc-quenching plate faces a coated broad side of an adjacent arc-quenching plate with a spacing D. This results in the broad side adjacent to the first arc guide rail 41 of the arc-quenching plate adjacent to the first arc guide rails 41 being coated, and the broad side adjacent to the second arc guide rail 42 of the arc-quenching plate adjacent to the second arc guide rail 42 being uncoated.

The embodiment according to FIG. 5 differs from that shown in FIG. 4 in that in each case coated broad sides of adjacent arc-quenching plates face one another, and uncoated broad sides of adjacent arc-quenching plates face one another. This embodiment can have an advantage that the lamina strip from which the quenching plates are stamped is only coated on one side. The alternate arrangement of coated and uncoated broad sides results from the 180° rotation which is desired for assembling the side strips 14, 15.

The embodiments of arc-quenching core assemblies according to the disclosure are not limited to those with 5 arc-quenching plates, but are possible for any desired number of arc-quenching plates. The number of arc-quenching plates used depends, for example, on the switching power and the geometrical and electrical dimensioning of the switching device; arc-quenching plate arrangements with 11 and 24 arc-quenching plates are cited by way of example.

Exemplary embodiments of arc-quenching core assemblies according to the disclosure include a the stack of arc-quenching plates, wherein two uncoated broad sides of a different arc-quenching plates lie between sequential coated broad sides (e.g., between a coated broad side of one arc-quenching plate and a next coated broad side of another arc-quenching plate). In the embodiments according to FIGS. 2 and 3, the two uncoated broad sides are those of each uncoated arc-quenching plate 212, 312 arranged between two coated arc-quenching plates 211, 311, respectively.

In the embodiment according to FIGS. 4 and 5, the next one coated broad side relative to an initial coated broad side belongs to the next one arc-quenching plate in the stack of arc-quenching plates. Accordingly, the two intermediate uncoated broad sides are in one case the uncoated broad side of the particular arc-quenching plate itself and the uncoated broad side of a directly adjacent arc-quenching plate.

As a consequence of the series of coated and uncoated broad sides of arc-quenching plates according to the disclosure, a first foot (i.e, base) of each sub-arc which occurs between two adjacent arc-quenching plates is located on a coated broad side of an arc-quenching plate, and a second foot on an uncoated broad side of an arc-quenching plate. This can maintain high arc mobility, as a result of which the thermal loading on the arc-quenching plates can be reduced, and also spattering of material on the surface of the arc-quenching plates with the resulting risk of the formation of a short-circuit between adjacent arc-quenching plates can be minimized.

As an alternative to completely coating a broad side of an arc-quenching plate, a coated broad side can also be only partially coated. FIGS. 6 and 7 show schematically two possible exemplary embodiments in a plan view of partially coated arc-quenching plates 611, 711. In FIG. 6, a strip 63 parallel to the longitudinal extension direction of the arc-quenching plate 611 is coated; the remaining part 64 remains uncoated. In the embodiment according to FIG. 7, a strip 73 parallel to the broad side of the arc-quenching plate 711 is coated; the remaining part 74 remains uncoated. Here, the arc-quenching plate 611, 711 is, for example, partially coated on both sides, that is to say on both broad sides of an arc-quenching plate.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An arc-quenching core assembly for an electric switch, comprising:
first arc-quenching plates made from ferromagnetic material and arranged parallel to one another, the plates being at least partially coated on at least one side with a coating material; and
second arc-quenching plates uncoated on at least one side, the first and second arc-quenching plates being configured in a series of coated and uncoated arc-quenching plate broad sides in a stacking direction, the arc-quenching plates being arranged behind one another in the stacking direction such that at least two uncoated arc-quenching plate broad sides are located between sequential coated arc-quenching plate broad sides in the stacking direction.

2. The arc-quenching core assembly as claimed in claim 1, wherein the arc-quenching plates are at least partially coated on both sides, and the second arc-quenching plates are uncoated on both sides.

3. The arc-quenching core assembly as claimed in claim 1, wherein each of the first arc-quenching plates and the second arc-quenching plates are at least partially coated on one side and uncoated on another side.

4. The arc-quenching core assembly as claimed in claim 1, wherein the arc-quenching core assembly comprises: an alternating series of arc-quenching plates completely coated on both sides and uncoated arc-quenching plates, such that every second arc-quenching plate in the stacking direction is uncoated.

5. The arc-quenching core assembly as claimed in claim 1, wherein the arc-quenching core assembly comprises:
an alternating series of arc-quenching plates partially coated on both sides and uncoated arc-quenching plates, such that every second arc-quenching plate in the stacking direction is uncoated.

6. The arc-quenching core assembly as claimed in claim 1, wherein the arc-quenching core assembly comprises:
an alternating series of arc-quenching plates completely coated on one side and uncoated on another side, such that, in the stacking direction, each coated arc-quenching plate broad side faces the coated arc-quenching plate broad side of an adjacent arc-quenching plate, and each uncoated arc-quenching plate broad side of an arc-quenching plate faces an uncoated arc-quenching plate broad side of an adjacent arc-quenching plate.

7. The arc-quenching core assembly as claimed in claim 1, wherein the arc-quenching core assembly comprises:
an alternating series of arc-quenching plates completely coated on one side and uncoated on another side, such that, in the stacking direction, each coated arc-quenching plate broad side of one arc-quenching plate faces an uncoated arc-quenching plate broad side of an adjacent arc-quenching plate.

8. The arc-quenching core assembly as claimed in claim 1, wherein the arc-quenching core assembly comprises:
an alternating series of arc-quenching plates partially coated on one side and uncoated arc-quenching plates, such that each partially coated arc-quenching plate broad side faces an uncoated arc-quenching plate broad side.

9. The arc-quenching core assembly as claimed in claim 1, wherein the arc-quenching core assembly comprises:
an alternating series of arc-quenching plates partially coated on one side and uncoated arc-quenching plates, such that each partially coated arc-quenching plate broad side of one arc-quenching plate faces an uncoated arc-quenching plate broad side of an adjacent arc-quenching plate.

10. The arc-quenching core assembly as claimed in claim 1, wherein the coating of the arc-quenching plates is made from an electrically conductive material.

11. The arc-quenching core assembly as claimed in claim 1, wherein when the plates are partially coated, a strip of the arc-quenching plate broad side which is oriented parallel to longitudinal or broad sides of the arc-quenching plate is coated.

12. The arc-quenching core assembly as claimed in claim 1, wherein the arc-quenching plates each have an approximately V-shaped recess.

13. The arc-quenching core assembly as claimed in claim 1, wherein the arc-quenching plates are retained at a distance with respect to one another by at least one retaining device made from insulating material.

14. The arc-quenching core assembly as claimed in claim 1, wherein the material of the coating is a composite material comprising:
a first constituent which is electrically conductive, and which has a melting point which does not exceed a melting point of a ferromagnetic material, and a vaporization point which does not exceed a vaporization point of the ferromagnetic material; and
a second constituent which has a melting point which is higher than the melting point of the ferromagnetic material and a vaporization point which is higher than the vaporization point of the ferromagnetic material.

15. An arc-quenching chamber with an arc-quenching core assembly according to claim 1 in combination with a contact point of a switch, and comprising:
two guide rails for guiding a switching arc which occurs at the contact point for cooling and quenching the switching arc.

16. The arc-quenching chamber as claimed in claim 15, wherein arc-quenching plates adjacent to the two arc guide rails are uncoated.

17. The arc-quenching chamber as claimed in claim 15, wherein arc-quenching plates adjacent to the two arc guide rails are coated.

18. An installation switching device having an arc-quenching chamber and an arc-quenching core assembly, the arc-quenching core assembly comprising:
first arc-quenching plates made from ferromagnetic material and arranged parallel to one another, the plates being at least partially coated on at least one side with a coating material; and
second arc-quenching plates uncoated on at least one side, the first and second arc-quenching plates being configured in a series of coated and uncoated arc-quenching plate broad sides in a stacking direction, the arc-quenching plates being arranged behind one another in the stacking direction such that at least two uncoated arc-quenching plate broad sides are located between sequential coated arc-quenching plate broad sides in the stacking direction.

19. The arc-quenching core assembly as claimed in claim 1, wherein the electric switch is at least one of a line-protection circuit breaker and a motor protection circuit breaker
